(19) United States
(12) Patent Application Publication
(10) Pub. No.: US 2026/0351972 A1
(43) Pub. Date: Nov. 5, 2026

(54) GRID-CONNECTED HARMONIC SUPPRESSION METHOD AND SYSTEM BASED ON CONVERTER COMPENSATION VECTOR ITERATION CONTROL

(71) Applicant: SHANDONG UNIVERSITY, Jinan (CN)

(72) Inventors: Yuanyuan SUN, Jinan (CN); Pengbo SHAN, Jinan (CN); Yirou LAI, Jinan (CN); Yahui LI, Jinan (CN); Qifan YANG, Jinan (CN); Mingchen WANG, Jinan (CN); Bowen LI, Jinan (CN); Xiaolei HOU, Jinan (CN); Jinghao TENG, Jinan (CN)

(21) Appl. No.: 19/385,414

(22) Filed: Nov. 11, 2025

(30) Foreign Application Priority Data
Apr. 30, 2025 (CN) 2025105653708

(51) Int. Cl. H02J 3/01

(52) U.S. Cl. CPC H02J 3/01

(57) ABSTRACT

The present invention belongs to the technical field of electric energy quality governance, and provides a grid-connected harmonic suppression method and system based on converter compensation vector iteration control. The method includes: generating a converter harmonic compensation voltage based on phase angle conversion of a grid-forming converter; performing compensation vector iteration control on the generated harmonic compensation voltage to obtain an optimal phase angle of the compensation voltage; increasing an amplitude of the harmonic compensation voltage according to the obtained optimal phase angle of the compensation voltage, and determining a direction of a harmonic current; and suppressing a grid-connected harmonic current according to the amplitude of the harmonic compensation voltage when the direction of the harmonic current changes to complete grid-connected harmonic suppression based on converter compensation vector iteration control.

### CROSS-REFERENCE TO RELATED APPLICATIONS

The present invention claims priority to Chinese Patent Application No. 202510565370.8, filed with the China National Intellectual Property Administration on Apr. 30, 2025 and entitled “GRID-CONNECTED HARMONIC SUPPRESSION METHOD AND SYSTEM BASED ON CONVERTER COMPENSATION VECTOR ITERATION CONTROL”, which is incorporated herein by reference in its entirety and constitutes a part of the present invention, and is used for all purposes.

### TECHNICAL FIELD

The present invention belongs to the technical field of electric energy quality governance, and specifically relates to a grid-connected harmonic suppression method and system based on converter compensation vector iteration control.

### BACKGROUND

The statements in this section merely provide background information related to the present invention, and do not necessarily constitute the prior art.

Because of advantages such as green, clean, and abundance of resources, new energy sources maintain a rapid increase posture in recent years, and the capacity of newly added machines has reached a record high. Different from conventional fossil energy sources, new energy sources are connected to an electric system by using low-inertial and fast-responding converters. In addition, new energy stations are mostly located in remote regions, and long-distance electric transmission causes the electric system to gradually present a weak grid feature. In a weak grid background, grid-side voltage distortion is increasingly severe, and non-linear load permeability gradually increases, causing a decrease in grid-connected current quality, and resulting in poor interference immunity of the grid, and potential threats to stable operation of the grid and guarantee of electric energy quality.

Most of new energy grid-connected converters use grid-following control. To enable the grid-following converter to actively suppress a harmonic current, a harmonic current control compensation method is usually used, and a harmonic current instruction has an amplitude and a phase that are the same as those of a non-linear load harmonic current by using detection methods of Fourier transform and instantaneous active and reactive power theories, so that the converter absorbs the load harmonic current. Compared with the grid-following converter with current source characteristics, a grid-forming converter regulates a voltage amplitude and frequency by simulating rotor dynamic characteristics of a synchronous generator, and presents voltage source characteristics. Because of a voltage source control mode of the grid-forming converter, a compensated component is equivalent to a harmonic voltage source rather than a harmonic current source. Therefore, it is difficult to counteract the non-linear load harmonic current. However, the compensation harmonic voltage source can counteract harmonics generated on the converter by grid-side background harmonics.

Therefore, how to effectively reduce the harmonic current generated on the grid-forming converter by a grid-side distortion voltage to improve the grid-connected point current quality needs to be researched urgently.

### SUMMARY

To solve the above problems, the present invention provides a grid-connected harmonic suppression method and system based on converter compensation vector iteration control. Vector iteration is performed on the amplitude and phase of a converter compensation voltage, so as to reduce harmonics transmitted by a grid-forming converter under a distorted grid, thereby improving a grid-connected current waveform in a short time, providing a real-time response when a grid condition changes, automatically adjusting the phase and amplitude of the compensation voltage, significantly suppressing the grid-connected point harmonic content, and effectively reducing impacts of grid background harmonics on grid-connected current harmonics.

According to some embodiments, a first aspect of the present invention provides a grid-connected harmonic suppression method based on converter compensation vector iteration control, which adopts the following technical solution.

A grid-connected harmonic suppression method based on converter compensation vector iteration control, including:
generating a converter harmonic compensation voltage based on phase angle conversion of a grid-forming converter;
performing compensation vector iteration control on the generated harmonic compensation voltage to obtain an optimal phase angle of the compensation voltage;
increasing an amplitude of the harmonic compensation voltage according to the obtained optimal phase angle of the compensation voltage, and determining a direction of a harmonic current; and
suppressing a grid-connected harmonic current according to the amplitude of the harmonic compensation voltage when the direction of the harmonic current changes to complete grid-connected harmonic suppression based on converter compensation vector iteration control.

As a further technical limitation, in the process of generating the converter harmonic compensation voltage based on the phase angle conversion of the grid-forming converter, considering that a voltage loop of the grid-forming converter is controlled in a dq coordinate system, phase angle conversion is performed on the harmonic compensation voltage by using a phase angle constructed by the grid-forming converter to generate a harmonic compensation voltage component in the dq coordinate system, and the generated harmonic compensation voltage component is superimposed to an input of the voltage loop of the grid-forming converter to obtain the converter harmonic compensation voltage.

As a further technical limitation, in the process of compensation vector iteration control, a phase angle of the compensation voltage is optimized based on a harmonic compensation voltage with a fixed amplitude and a variable-step-length phase angle, iterative correction is performed on the phase angle of the compensation voltage, a direction of a maximum decrease of a grid-connected point harmonic voltage is searched, and the obtained direction of the maximum decrease is used as an optimized phase angle, that is, the phase angle of the compensation voltage.

Further, when a grid-side harmonic compensation voltage is not added, a grid-connected point harmonic voltage u_{PCC}(s) is:

$${u}_{PCC} ( s ) = {u}_{g} ( s ) + {i}_{g} ( s ) {Z}_{g} ( s ) = \frac{{i}_{Load} ( s ) {Z}_{g} ( s ) {Z}_{o} ( s ) + {u}_{g} ( s ) {Z}_{o} ( s )}{{Z}_{o} ( s ) + {Z}_{g} ( s )} ;$$

wherein, i_{Load}(S), i_{g}(s), and u_{g}(s) are respectively a load current, a grid current, and a grid voltage, and Z_{g}(s) and Zₒ(s) are respectively a grid impedance equivalent output impedance and a converter equivalent output impedance.

After a grid-side harmonic compensation voltage is added, an updated grid-connected point harmonic voltage u_{PCC}(s)* is:

$${{u}_{PCC} ( s )}^{*} = {u}_{g} ( s ) + {i}_{g} ( s ) {Z}_{g} ( s ) = \frac{\begin{matrix}{i}_{Load} ( s ) {Z}_{g} ( s ) {Z}_{o} ( s ) + \\ {u}_{g} ( s ) {Z}_{o} ( s ) + {u}_{add} ( s ) {Z}_{g} ( s )\end{matrix}}{{Z}_{o} ( s ) + {Z}_{g} ( s )} ;$$

wherein, u_{add}(s) is the grid-side harmonic compensation voltage.

An optimal phase angle of the compensation voltage characterizes that a most sensitive state of the grid-connected point harmonic voltage to a variation of the amplitude of the compensation voltage, that is, a decrease rate of the grid-connected point harmonic voltage is the fastest, and the optimal phase angle θ_{addh}* of the compensation voltage is:

$${θ}_{addh}^{*} = {arg max}_{{θ}_{addh}} \frac{\partial \vert {u}_{P C C} ( s ) \vert}{\partial \vert Δ {u}_{a d d} ( s ) \vert} ;$$

wherein, Δu_{add}(s) is the variation of the compensation voltage.

It should be noted that in a process in which the decrease rate of the grid-connected point harmonic voltage is the fastest, iteration is performed on the phase angle of the compensation voltage from 0 rad to 360 rad according to a fixed step length, and amplitudes of the grid-connected point harmonic voltage before and after the compensation voltage is added at each iterative phase angle are recorded. The optimal phase angle is an iterative phase angle corresponding to a maximum change of the amplitude of the grid-connected point harmonic voltage.

As a further technical limitation, in the process of compensation vector iteration control, a grid-connected point harmonic voltage is greater than a converter output harmonic voltage, and the direction of the harmonic current is from a grid-connected point to a converter. In the process of increasing the amplitude of the harmonic compensation voltage, the converter outputs a reverse harmonic current, that is, the direction of the current outputted by the converter is the same as the direction of the grid-connected harmonic current, and the grid-connected point harmonic voltage approaches a grid harmonic voltage. When the grid-connected point harmonic voltage is consistent with the grid harmonic voltage, the direction of the harmonic current changes, and the increase of the amplitude of the harmonic compensation voltage is stopped to complete the suppression of the grid-connected harmonic current.

As a further technical limitation, the grid-connected harmonic suppression method based on converter compensation vector iteration control further includes multi-order compensation voltage vector iteration control. Iteration is performed gradually from a low order to a high order during the multi-order compensation voltage vector iteration control until the suppression of the grid-connected harmonic current is completed.

It should be noted that for different orders of harmonic compensation voltages, the optimal phase angle is iteratively searched by fixing the amplitude of the compensation voltage and changing a compensation phase, and then, the amplitude of the compensation voltage is gradually increased until the harmonic current is reversed to achieve an effect of suppressing a corresponding order of harmonic current. Adding the harmonic compensation voltage may affect the magnitude of a modulation voltage. If compensation amplitude is excessively large, the modulation voltage may exceed a range, affecting the normal operation of a switching tube, and reducing the operating efficiency of a system. Multi-order harmonics such as 5, 7, and 11 are gradually performed, and after the 5-order harmonic compensation voltage is added, the amplitude of the modulation voltage is correspondingly increased. Therefore, when the amplitude of the 7-order harmonic compensation voltage is determined, a limit on the amplitude of the modulation voltage after the 5-order harmonic compensation voltage is added needs to be considered, and a limit value thereof is

$$\frac{{U}_{d c}}{2} ′$$

where U_{dc} is an amplitude of a direct current side voltage.

According to some embodiments, a second aspect of the present invention provides a grid-connected harmonic suppression system based on converter compensation vector iteration control, which adopts the following technical solution.

A grid-connected harmonic suppression system based on converter compensation vector iteration control, including:
an obtaining module, configured to generate a converter harmonic compensation voltage based on phase angle conversion of a grid-forming converter;
an optimizing module, configured to perform compensation vector iteration control on the generated harmonic compensation voltage to obtain an optimal phase angle of the compensation voltage;
a determining module, configured to increase an amplitude of the harmonic compensation voltage according to the obtained optimal phase angle of the compensation voltage, and determine a direction of a harmonic current; and
a suppression module, configured to suppress a grid-connected harmonic current according to the amplitude of the harmonic compensation voltage when the direction of the harmonic current changes to complete grid-connected harmonic suppression based on converter compensation vector iteration control.

According to some embodiments, a third aspect of the present invention provides a non-transitory computer-readable storage medium, which adopts the following technical solution.

A non-transitory computer-readable storage medium, having a program stored thereon, wherein when the program is executed by a processor, causing the processor to implement steps in the grid-connected harmonic suppression method based on converter compensation vector iteration control according to the first aspect of the present invention.

According to some embodiments, a fourth aspect of the present invention provides an electronic device, which adopts the following technical solution.

An electronic device, including a memory, a processor, and a program stored in the memory and running on the processor, wherein when executing the program, the processor implements steps in the grid-connected harmonic suppression method based on converter compensation vector iteration control according to the first aspect of the present invention.

According to some embodiments, a fifth aspect of the present invention provides a computer program product, which adopts the following technical solution.

A computer program product, including software code, wherein a program in the software code performs steps in the grid-connected harmonic suppression method based on converter compensation vector iteration control according to the first aspect of the present invention.

Compared with the prior art, the present invention has the following beneficial effects:
according to the present invention, vector iteration is performed on the amplitude and phase of the converter compensation voltage, so as to reduce harmonics transmitted by the grid-forming converter under a distorted grid, thereby improving a grid-connected current waveform in a short time, providing a real-time response when a grid condition changes, automatically adjusting the phase and amplitude of the compensation voltage, significantly suppressing the grid-connected point harmonic content, and effectively reducing impacts of grid background harmonics on grid-connected current harmonics.

### BRIEF DESCRIPTION OF THE DRAWINGS

The accompanying drawings of the specification that constitute a part of the present embodiment are used for providing a further understanding of the present embodiment. Exemplary examples of the present embodiment and descriptions thereof are used for explaining the present embodiment, and do not constitute an inappropriate limitation to the present embodiment.

FIG. 1 is a flowchart of a grid-connected harmonic suppression method based on converter compensation vector iteration control in Example 1 of the present invention.

FIG. 2 is a schematic diagram of detailed steps of the grid-connected harmonic suppression method based on converter compensation vector iteration control in Example 1 of the present invention.

FIG. 3 is a topology structural diagram of a grid-forming converter in Example 1 of the present invention.

FIG. 4 is a control block diagram of converter compensation vector iteration control in Example 1 of the present invention.

FIG. 5 is a structural block diagram of a grid-connected harmonic suppression system based on converter compensation vector iteration control in Example 2 of the present invention.

### DETAILED DESCRIPTION

The present invention is further described below with reference to accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, terms “comprise/comprising” and/or “include/including” used in this specification indicate that there are features, steps, operations, devices, components, and/or combinations thereof.

In a case of no conflict, embodiments in the present invention and features in the embodiments may be combined with each other.

### Example 1

The example 1 of the present invention discloses a grid-connected harmonic suppression method based on converter compensation vector iteration control.

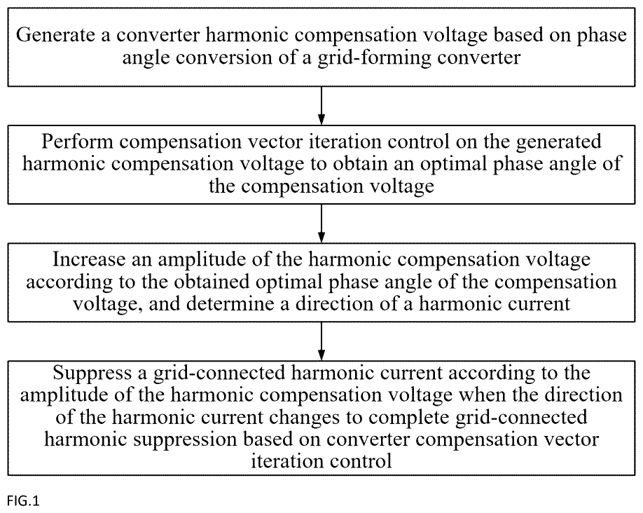

The grid-connected harmonic suppression method based on converter compensation vector iteration control shown in FIG. 1 includes:
a converter harmonic compensation voltage is generated based on phase angle conversion of a grid-forming converter;
compensation vector iteration control is performed on the generated harmonic compensation voltage to obtain an optimal phase angle of the compensation voltage;
an amplitude of the harmonic compensation voltage is increased according to the obtained optimal phase angle of the compensation voltage, and a direction of a harmonic current is determined; and
a grid-connected harmonic current is suppressed according to the amplitude of the harmonic compensation voltage when the direction of the harmonic current changes to complete grid-connected harmonic suppression based on converter compensation vector iteration control.

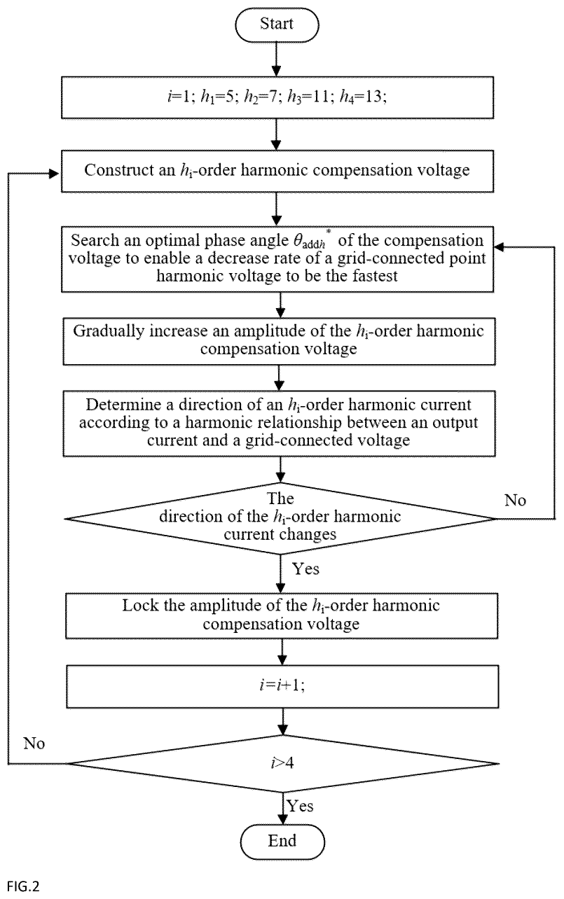

The present example provides a real-time response when a grid condition changes, thereby automatically adjusting a phase and an amplitude of a compensation voltage, achieving a better suppression effect on a grid-connected harmonic current generated by grid background harmonics, improving the universality of the suppression method, and providing a reliable technical support for large-scale new energy access. Detailed steps of grid-connected harmonic suppression are introduced with reference to FIG. 2:
a 5-order compensation voltage is constructed, that is, the 5-order compensation voltage is introduced into a reference voltage inputted from a voltage loop, so as to reduce a harmonic component transmitted by the grid-forming converter under a distorted grid;
an optimal phase angle of the compensation voltage is identified, that is, vector iteration control is performed by using a compensation voltage instruction with a fixed amplitude and a variable-step-length phase angle, so as to search a phase angle of the compensation voltage at which a grid-connected point harmonic voltage decreases fastest, and determine the optimal phase angle of the compensation voltage; and
an amplitude of the compensation voltage is determined, that is, the amplitude of the harmonic compensation voltage is gradually increased based on the optimal phase angle of the compensation voltage, the direction of the harmonic current is determined by analyzing a harmonic relationship between a modulation voltage and a grid-connected point harmonic voltage, and the amplitude of the compensation voltage is locked when the harmonic flow direction changes.

Multi-order compensation voltage vector iteration control means that after a phase angle and an amplitude of the 5-order compensation voltage are determined, 7-order, 11-order, and 13-order harmonic compensation voltages are constructed in sequence by using a similar vector iteration control policy, thereby implementing simultaneous suppression of multi-order grid-connected harmonic currents.

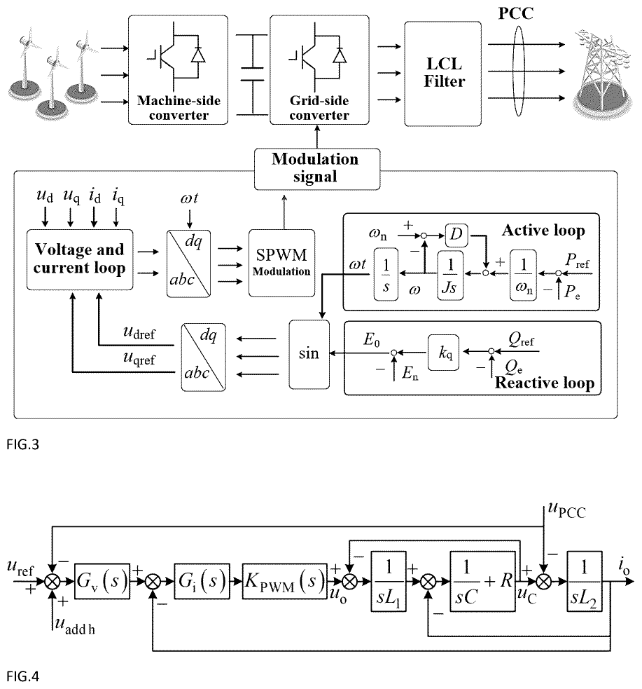

In the present example, the 5-order harmonic voltage is converted by using a phase angle constructed by the grid-forming converter shown in FIG. 3. Considering that the voltage loop of the grid-forming converter is controlled in a dq coordinate system, phase angle conversion is performed on the harmonic compensation voltage by using the phase angle constructed by the grid-forming converter to generate a harmonic compensation voltage component in the dq coordinate system, and the generated harmonic compensation voltage component is superimposed to an input of the voltage loop of the grid-forming converter to obtain the converter harmonic compensation voltage. The obtained harmonic compensation voltage is superimposed to an input of a voltage outer loop, so that the reference voltage is increased by a corresponding harmonic content. The compensation voltage corresponding to the grid background harmonics is added to counteract the impact of the grid background harmonics on the grid-connected current, optimize the quality of the grid-connected point current, and improve a capability of the grid-forming converter to actively suppress harmonics.

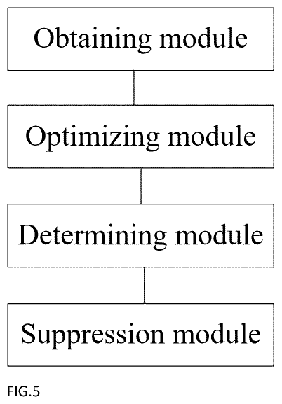

In the present example, converter compensation vector iteration control is performed with reference to FIG. 4. Specifically, the constructed phase angle of the compensation voltage is first optimized by using a compensation voltage instruction with a fixed amplitude and a variable-step-length phase angle, iterative correction is performed on the phase angle of the compensation voltage, a direction of a maximum decrease of the grid-connected point harmonic voltage is searched, and an optimized phase angle is locked as the phase angle of the compensation voltage.

It should be noted that in the present example, s=jhω₀, where j is a complex unit in the complex frequency domain, h is a harmonic order, and ω₀ is a fundamental wave angular frequency.

In the present example, when a grid-side harmonic compensation voltage is not added, a grid-connected point harmonic voltage u_{PCC}(s) is:

$${u}_{P C C} ( s ) = {u}_{g} ( s ) + {i}_{g} ( s ) {Z}_{g} ( s ) = \frac{{i}_{L o a d} ( s ) {Z}_{g} ( s ) {Z}_{o} ( s ) + {u}_{g} ( s ) {Z}_{o} ( s )}{{Z}_{o} ( s ) + {Z}_{g} ( s )} ;$$

wherein, i_{Load}(S), i_{g} S, and u_{g} S are respectively a load current, a grid current, and a grid voltage, and Z_{g}(s) and Zₒ(s) are respectively a grid impedance equivalent output impedance and a converter equivalent output impedance.

After a grid-side harmonic compensation voltage is added, an updated grid-connected point harmonic voltage u_{PCC}(s)* is:

$${{u}_{P C C} ( s )}^{*} = {u}_{g} ( s ) + {i}_{g} ( s ) {Z}_{g} ( s ) = \frac{{i}_{L o a d} ( s ) {Z}_{g} ( s ) {Z}_{o} ( s ) + {u}_{g} ( s ) {Z}_{o} ( s ) + {u}_{a d d} ( s ) {Z}_{g} ( s )}{{Z}_{o} ( s ) + {Z}_{g} ( s )} ;$$

wherein, u_{add}(s) is the grid-side harmonic compensation voltage.

An optimal phase angle of the compensation voltage characterizes that a most sensitive state of the grid-connected point harmonic voltage to a variation of the amplitude of the compensation voltage, that is, a decrease rate of the grid-connected point harmonic voltage is the fastest, and the optimal phase angle θ_{addh}* of the compensation voltage is:

$${θ}_{addh}^{*} = {arg max}_{{θ}_{addh}} \frac{\partial \vert {u}_{P C C} ( s ) \vert}{\partial \vert Δ {u}_{a d d} ( s ) \vert} ;$$

wherein, Δu_{add}(s) is the variation of the compensation voltage.

It should be noted that in a process in which the decrease rate of the grid-connected point harmonic voltage is the fastest, iteration is performed on the phase angle of the compensation voltage from 0 rad to 360 rad according to a fixed step length, and amplitudes of the grid-connected point harmonic voltage before and after the compensation voltage is added at each iterative phase angle are recorded. The optimal phase angle is an iterative phase angle corresponding to a maximum change of the amplitude of the grid-connected point harmonic voltage.

Because a voltage reference instruction outputted by a power controller only includes amplitude and phase information of a fundamental wave voltage, the grid-connected point harmonic voltage is higher than the converter output harmonic voltage. In this case, the harmonic current flows from the grid-connected point to the converter. The relationship between the grid-connected point harmonic voltage and the harmonic voltage in the converter modulation signal is:

$${u}_{P C C} ( s ) = {u}_{o} ( s ) + L \frac{d {i}_{o} ( s )}{d t} \approx {u}_{m o d} ( s ) + L \frac{d {i}_{o} ( s )}{d t}$$

wherein, u_{PCC}(s) is the grid-connected point harmonic voltage, uₒ(s) is the converter output voltage, u_{mod}(s) is the modulation signal, L is an inductance of converter side, and iₒ(s) is the converter output current.

In a process in which the amplitude of the compensation voltage gradually increases, the harmonic current outputted by the converter is reversed. In this case, the relationship between the grid-connected point harmonic voltage and the harmonic voltage in the converter modulation signal is:

$${u}_{P C C} ( s ) = {u}_{o} ( s ) - L \frac{d {i}_{o} ( s )}{d t} \approx {u}_{m o d} ( s ) - L \frac{d {i}_{o} ( s )}{d t} .$$

Because the flow direction of the output harmonic current and the flow direction of the grid-connected harmonic current synchronously change, in this process, the grid-connected point harmonic voltage gradually approaches the grid harmonic voltage. By collecting and analyzing the harmonic relationship among the modulation voltage, the output current, and the grid-connected voltage, determining a time of changing of the direction of the harmonic current, and a variable HFD representing the direction of the harmonic current is defined according to their harmonic relationship, as follows:

$$HFD = \vert {u}_{P C C} ( jh {ω}_{0} ) \vert - \vert {u}_{m o d} ( jh {ω}_{0} ) - L \frac{d {i}_{o} ( jh {ω}_{0} )}{d t} \vert ;$$

The amplitude of the harmonic compensation voltage is gradually increased according to a phase angle vector iteration result of the harmonic compensation voltage. When an inflection point of a change of the harmonic relationship is searched, the vector iteration process is terminated, and amplitude at the inflection point is obtained and locked as the amplitude of the harmonic compensation voltage. The final determination of the harmonic voltage compensation amplitude needs to be iteratively completed in sequence, that is:

$$\begin{matrix}\{ \begin{matrix}{u}_{addh} = {u}_{add 0} + Δ {u}_{addh} {K}_{T} \\ h = \{ 5 , 7 , 11 , 13 \}\end{matrix} \\ s . t . HDF \leq 0.5 \% {U}_{n}\end{matrix} ;$$

wherein, u_{addo} is a basic value for starting iteration, Δu_{addh} is an iteration step length, KT is a number of iterations, and Un is a rated voltage amplitude.

Adding a compensation voltage may affect the magnitude of the modulation voltage. If compensation amplitude is excessively large, the modulation voltage may exceed a range, affecting the normal operation of a switching tube, and reducing the operating efficiency of a system. Therefore, the selection of the amplitude of the harmonic compensation voltage also needs to consider the limitation of the modulation voltage, so as to ensure that the compensation voltage may not cause the modulation voltage to exceed a safe range, that is, the compensation voltage should meet u_{addh}<0.8×(U_{dc}/2−U_{modh}), where U_{dc} is an amplitude of a direct current side output voltage, and U_{modh} is the h-order harmonic component in the modulation voltage.

In the present example, for suppression of 5-order harmonics, vector iteration control is performed by using a 5-order harmonic compensation voltage instruction with fixed amplitude and a variable-step-length phase. In this process, an optimal compensation phase may be determined by searching a direction in which the compensation voltage enables a decrease rate of the grid-connected point harmonic voltage to be the fastest. Subsequently, the amplitude of the compensation voltage is gradually increased until the 5-order harmonic current is reversed, so that the effect of suppressing the grid-connected 5-order harmonic current is achieved, and the iteration process is terminated.

Because lower-order harmonics have more content than higher-order harmonics, the vector iteration control policy starts from lower-order harmonic compensation, and the amplitude of the harmonic compensation voltage is limited by the global modulation voltage. Therefore, the amplitude of the higher-order harmonic compensation voltage needs to be adjusted based on the lower-order compensation.

A 7-order compensation voltage is constructed, and a similar vector iteration control policy is used for processing. For the 7-order compensation voltage, vector iteration control is still performed by using a compensation voltage instruction with fixed amplitude and a variable-step-length phase to ensure that a compensation signal can be adjusted in time according to a system change. However, in this process, because the control policy for the 5-order harmonics has been improved, the amplitude of the modulation voltage may be increased. Therefore, although the vector iteration control policy of the 7-order compensation voltage maintains unchanged, after the lower-order harmonic compensation voltage is added, a range for setting an amplitude of the higher-order harmonic compensation voltage is reduced, and a theoretical optimal value may not be obtained. Consequently, a higher-order harmonic suppression effect is weaker than an effect obtained when compensation is performed alone. However, relevant parameters need to be set in consideration of the impact caused by construction of the 5-order compensation voltage, so as to avoid mutual interference of parameters in a system, ensure simultaneous suppression of multi-order harmonics, and perform order-by-order compensation (5-order→7-order→11-order→13-order) according to each order of harmonic content of the grid-connected point current. A particular order of harmonic compensation voltage is added to monitor the amplitude of the modulation voltage, and an adjustment space of an amplitude of a next order of harmonic compensation voltage is updated, so as to ensure that the addition of a subsequent order of harmonic compensation voltage does not cause the amplitude of the modulation voltage to exceed a limit value. Other orders of harmonics are the same.

In the present example, vector iteration is performed on the amplitude and phase of the converter compensation voltage, so as to reduce harmonics transmitted by the grid-forming converter under a distorted grid, thereby improving a grid-connected current waveform in a short time, providing a real-time response when a grid condition changes, automatically adjusting the phase and amplitude of the compensation voltage, significantly suppressing the grid-connected point harmonic content, and effectively reducing impacts of grid background harmonics on grid-connected current harmonics.

### Example 2

The example 2 of the present invention introduces a grid-connected harmonic suppression system based on converter compensation vector iteration control.

A grid-connected harmonic suppression system based on converter compensation vector iteration control shown in FIG. 5 includes:
an obtaining module, configured to generate a converter harmonic compensation voltage based on phase angle conversion of a grid-forming converter;
an optimizing module, configured to perform compensation vector iteration control on the generated harmonic compensation voltage to obtain an optimal phase angle of the compensation voltage;
a determining module, configured to increase an amplitude of the harmonic compensation voltage according to the obtained optimal phase angle of the compensation voltage, and determine a direction of a harmonic current; and
a suppression module, configured to suppress a grid-connected harmonic current according to the amplitude of the harmonic compensation voltage when the direction of the harmonic current changes to complete grid-connected harmonic suppression based on converter compensation vector iteration control.

Detailed steps are the same as those of the grid-connected harmonic suppression method based on converter compensation vector iteration control provided in Example 1, and details are not repeated herein.

### Example 3

The example 3 of the present invention provides a computer-readable storage medium.

A computer-readable storage medium, being non-transitory and having a program stored thereon, wherein when the program is executed by a processor, causing the processor to implement steps in the grid-connected harmonic suppression method based on converter compensation vector iteration control according to Example 1 of the present invention.

Detailed steps are the same as those of the grid-connected harmonic suppression method based on converter compensation vector iteration control provided in Example 1, and details are not repeated herein.

### Example 4

The example 4 of the present invention provides an electronic device.

An electronic device, including a memory, a processor, and a program stored in the memory and running on the processor. When executing the program, the processor implements steps in the grid-connected harmonic suppression method based on converter compensation vector iteration control according to Example 1 of the present invention.

Detailed steps are the same as those of the grid-connected harmonic suppression method based on converter compensation vector iteration control provided in Example 1, and details are not repeated herein.

### Example 5

The example 5 of the present invention provides a computer program product.

A computer program product, including software code. A program in the software code performs steps in the grid-connected harmonic suppression method based on converter compensation vector iteration control according to Example 1 of the present invention.

Detailed steps are the same as those of the grid-connected harmonic suppression method based on converter compensation vector iteration control provided in Example 1, and details are not repeated herein.

Those skilled in the art should understand that the embodiments of the present invention may be provided as methods, systems, or computer program products. Therefore, the present invention may adopt a form of a hardware-only embodiment, a software-only embodiment, or an embodiment combining software and hardware. Moreover, the present invention may adopt a form of a computer program product implemented on one or more computer-available storage media (including but not limited to a disk memory, a CD-ROM, an optical memory, and the like) that include computer-available program code. Solutions in the embodiments of the present invention may be implemented by using various computer languages, for example, an object-oriented programming language Java and an interpreted scripting language JavaScript.

The present invention is described with reference to flowcharts and/or block diagrams of the method, the device (system), and the computer program product according to the embodiments of the present invention. It should be understood that computer program instructions may be used for implementing each process and/or each block in the flowcharts and/or the block diagrams and a combination of processes and/or blocks in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of another programmable data processing device generate an apparatus for implementing a specific function in one or more processes in the flowcharts and/or in one or more blocks in the block diagrams.

These computer program instructions may also be stored in a computer-readable memory that can instruct the computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operation steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although preferred embodiments of the present invention have been described, those skilled in the art can make additional changes and modifications to these embodiments once they learn the basic inventive concept. Therefore, the appended claims are intended to be construed as including the preferred embodiments and all changes and modifications falling within the scope of the present invention.

Apparently, those skilled in the art may make various changes and variations to the present invention without departing from the spirit and scope of the present invention. In this way, if these modifications and variations of the present invention fall within the scope of the claims of the present invention and equivalent technologies thereof, the present invention is also intended to cover these modifications and variations.

The foregoing descriptions are merely preferred embodiments of the present example, but are not intended to limit the present example. Those skilled in the art may make various modifications and changes to the present example. Any modification, equivalent replacement, or improvement made within the spirit and principle of the present example shall fall within the protection scope of the present example.

1. A grid-connected harmonic suppression method based on converter compensation vector iteration control, comprising:
generating a converter harmonic compensation voltage based on phase angle conversion of a grid-forming converter;
performing compensation vector iteration control on the generated harmonic compensation voltage to obtain an optimal phase angle of the compensation voltage;
increasing an amplitude of the harmonic compensation voltage according to the obtained optimal phase angle of the compensation voltage, and determining a direction of a harmonic current; and
suppressing a grid-connected harmonic current according to the amplitude of the harmonic compensation voltage when the direction of the harmonic current changes to complete grid-connected harmonic suppression based on converter compensation vector iteration control;
wherein, the optimal phase angle of the compensation voltage characterizes that a most sensitive state of the grid-connected point harmonic voltage to a variation of the amplitude of the compensation voltage, at this time, a decrease rate of the grid-connected point harmonic voltage is the fastest, and the optimal phase angle θ_{addh}* of the compensation voltage is:
$${θ}_{addh}^{*} = {arg max}_{{θ}_{addh}} \frac{\partial \vert {u}_{P C C} ( s ) \vert}{\partial \vert Δ {u}_{a d d} ( s ) \vert} ;$$
wherein, Δu_{add}(s) is the variation of the compensation voltage; u_{PCC}(s) is the grid-connected point harmonic voltage;
wherein, collecting and analyzing a harmonic relationship among a modulation voltage, an output current, and a grid-connected voltage, determining a time of changing of the direction of the harmonic current, and defining a variable HFD representing the direction of the harmonic current according to the harmonic relationship, the variable HFD is as follows:
$$HFD = \vert {u}_{P C C} ( jh {ω}_{0} ) \vert - \vert {u}_{m o d} ( jh {ω}_{0} ) - L \frac{d {i}_{o} ( jh {ω}_{0} )}{d t} \vert ;$$
wherein, u_{PCC}(jhω₀) is the, u_{mod}(jhω₀) is a modulating signal, iₒ(jhω₀) is an output current of the grid-forming converter, h is a harmonic order, and ω₀ is a fundamental wave angular frequency.

2. The grid-connected harmonic suppression method based on converter compensation vector iteration control according to claim 1, wherein in the process of generating the converter harmonic compensation voltage based on the phase angle conversion of the grid-forming converter, considering that a voltage loop of the grid-forming converter is controlled in a dq coordinate system, phase angle conversion is performed on the harmonic compensation voltage by using a phase angle constructed by the grid-forming converter to generate a harmonic compensation voltage component in the dq coordinate system, and the generated harmonic compensation voltage component is superimposed to an input of the voltage loop of the grid-forming converter to obtain the converter harmonic compensation voltage.

3. The grid-connected harmonic suppression method based on converter compensation vector iteration control according to claim 1, wherein in the process of compensation vector iteration control, a phase angle of the compensation voltage is optimized based on a harmonic compensation voltage with a fixed amplitude and a variable-step-length phase angle, iterative correction is performed on the phase angle of the compensation voltage, a direction of a maximum decrease of a grid-connected point harmonic voltage is searched, and the obtained direction of the maximum decrease is used as an optimized phase angle, that is, the phase angle of the compensation voltage.

4. The grid-connected harmonic suppression method based on converter compensation vector iteration control according to claim 3, wherein when a grid-side harmonic compensation voltage is not added, a grid-connected point harmonic voltage u_{PCC}(s) is:
$${u}_{P C C} ( s ) = {u}_{g} ( s ) + {i}_{g} ( s ) {Z}_{g} ( s ) = \frac{{i}_{L o a d} ( s ) {Z}_{g} ( s ) {Z}_{o} ( s ) + {u}_{g} ( s ) {Z}_{o} ( s )}{{Z}_{o} ( s ) + {Z}_{g} ( s )} ;$$
wherein, i_{Load}(s), i_{g}(s), and u_{g}(s) are respectively a load current, a grid current, and a grid voltage, and Z_{g}(s) and Zₒ(s) are respectively a grid impedance equivalent output impedance and a converter equivalent output impedance;
after a grid-side harmonic compensation voltage is added, an updated grid-connected point harmonic voltage u_{PCC}(s)* is:
$${{u}_{P C C} ( s )}^{*} = {u}_{g} ( s ) + {i}_{g} ( s ) {Z}_{g} ( s ) = \frac{{i}_{L o a d} ( s ) {Z}_{g} ( s ) {Z}_{o} ( s ) + {u}_{g} ( s ) {Z}_{o} ( s ) + {u}_{a d d} ( s ) {Z}_{g} ( s )}{{Z}_{o} ( s ) + {Z}_{g} ( s )} ;$$
wherein, u_{add}(s) is the grid-side harmonic compensation voltage.

5. The grid-connected harmonic suppression method based on converter compensation vector iteration control according to claim 1, wherein in the process of compensation vector iteration control, a grid-connected point harmonic voltage is greater than a converter output harmonic voltage, and the direction of the harmonic current is from a grid-connected point to a converter;
in the process of increasing the amplitude of the harmonic compensation voltage, the converter outputs a reverse harmonic current, that is, the direction of the current outputted by the converter is the same as the direction of the grid-connected harmonic current, and the grid-connected point harmonic voltage approaches a grid harmonic voltage; and when the grid-connected point harmonic voltage is consistent with the grid harmonic voltage, the direction of the harmonic current changes, and the increase of the amplitude of the harmonic compensation voltage is stopped to complete the suppression of the grid-connected harmonic current.

6. The grid-connected harmonic suppression method based on converter compensation vector iteration control according to claim 1, further comprising multi-order compensation voltage vector iteration control, wherein iteration is performed gradually from a low order to a high order during the multi-order compensation voltage vector iteration control until the suppression of the grid-connected harmonic current is completed.

7. A grid-connected harmonic suppression system based on converter compensation vector iteration control, comprising:
an obtaining module, configured to generate a converter harmonic compensation voltage based on phase angle conversion of a grid-forming converter;
an optimizing module, configured to perform compensation vector iteration control on the generated harmonic compensation voltage to obtain an optimal phase angle of the compensation voltage;
a determining module, configured to increase an amplitude of the harmonic compensation voltage according to the obtained optimal phase angle of the compensation voltage, and determine a direction of a harmonic current; and
a suppression module, configured to suppress a grid-connected harmonic current according to the amplitude of the harmonic compensation voltage when the direction of the harmonic current changes to complete grid-connected harmonic suppression based on converter compensation vector iteration control;
wherein, the optimal phase angle of the compensation voltage characterizes that a most sensitive state of the grid-connected point harmonic voltage to a variation of the amplitude of the compensation voltage, at this time, a decrease rate of the grid-connected point harmonic voltage is the fastest, and the optimal phase angle θ_{addh}* of the compensation voltage is:
$${θ}_{addh}^{*} = {arg max}_{{θ}_{addh}} \frac{\partial \vert {u}_{P C C} ( s ) \vert}{\partial \vert Δ {u}_{a d d} ( s ) \vert} ;$$
wherein, Δu_{add}(s) is the variation of the compensation voltage; u_{PCC}(s) is the grid-connected point harmonic voltage;
wherein, collecting and analyzing a harmonic relationship among a modulation voltage, an output current, and a grid-connected voltage, determining a time of changing of the direction of the harmonic current, and defining a variable HFD representing the direction of the harmonic current according to the harmonic relationship, the variable HFD is as follows:
$$HFD = \vert {u}_{P C C} ( jh {ω}_{0} ) \vert - \vert {u}_{m o d} ( jh {ω}_{0} ) - L \frac{d {i}_{o} ( jh {ω}_{0} )}{d t} \vert ;$$
wherein, u_{PCC}(jω₀) is the grid-connected point harmonic voltage, u_{mod}(jhω₀) is a modulating signal, iₒ(jhω₀) is an output current of the grid-forming converter, h is a harmonic order, and ω₀ is a fundamental wave angular frequency.

8. A non-transitory computer-readable storage medium, having a computer program stored thereon, wherein when the computer program is executed by a processor, causing the processor to implement steps of the grid-connected harmonic suppression method based on converter compensation vector iteration control according to claim 1.

9. An electronic device, comprising a memory, a processor, and a computer program stored in the memory and running on the processor, wherein when executing the computer program, the processor implements steps of the grid-connected harmonic suppression method based on converter compensation vector iteration control according to claim 1.

10. A computer program product, comprising software code, wherein when executing a computer program in the software code, steps of the grid-connected harmonic suppression method based on converter compensation vector iteration control according to claim 1 are performed.
